(19) United States
(12) Patent Application Publication
(10) Pub. No.: US 2010/0005156 A1
(43) Pub. Date: Jan. 7, 2010

(54) System and method for data acquisition and process and processing

(76) Inventor: Philip Wesby, Stratford-upon-Avon (GB)

Correspondence Address: FLYNN THIEL BOUTELL & TANIS, P.C., 2026 RAMBLING ROAD, KALAMAZOO, MI, 49008-1631, US

(21) Appl. No.: 12/311,632

(22) PCT Filed: Oct. 2, 2007
(86) PCT No.: PCT/GB2007/003716

§ 371 Date: Apr. 6, 2009

(30) Foreign Application Priority Data
Oct. 6, 2006 (GB) 0619761.0

(51) Int. Cl. G06F 15/16; G06F 15/173

(52) U.S. Cl. 709/219; 709/225

(57) ABSTRACT

A system and method for data acquisition and processing is described which can form the basis of new and improved business and consumer services. A subscriber captures the image of an encoded datagram associated with a product or service using a mobile phone or PDA or fixed line device and transmits this to a remote data processing centre. The captured datagram may comprise a variety of geometric shapes and language characters and even some custom graphics which may be processed in relation to a subscriber's profile stored in the device. The profile is used to provide different levels of quality of service and authentication for access to services in accordance with the subscriber's access rights. The destination IP address or mobile number used to access the service is encoded within the datagram itself so the subscriber need only ‘point and click’ and the software application can both identify, decode and direct a newly compiled data message to a known destination. In this way a variety of datagrams may be created, each comprising their own unique destination mobile number or IP address where each may be associated with very unique data services or system control services. Communication with a specific data processing centre may be via fixed line ADSL or via 3G services or GPRS or WIMAX or Wireless USB or be converted into an SMS text message. The remote server processes the captured data and either provides information back to the sender of the information or to their email address or initiates a process. Applications include data services, process control such as car park barriers, secure software purchasing such as ordering games from magazines where the software is forwarded to a known email address. Other applications include timetable updates for travel guides, or on advertisements, or in technical journals, or on food constituent labels, so that the data can be compared with current source data and dynamically updated as required to thereby replace or enhance the published information. This invention provides a powerful dimension to search engine companies bringing retail markets and consumer interest closer together through simplified intelligent messaging.

### BACKGROUND OF THE INVENTION

The invention relates to a system and method for data acquisition and processing and processing. More particularly, it relates to a system and method for capturing and or processing encoded information in the form of a structured composite data icon or datagram and transmitting this icon or the data extracted from it to a remote data server.

In particular, the invention relates to a system and method for capturing and or processing a stored or received encoded datagram and either processing it locally in the data capture device or relaying the datagram to a remote server for decoding wherein the datagram or data from it causes a process to occur such as updated information being sent back to the data capture device, or to some other data receiving device, or wherein the data capture process and communication with the remote data server causes a sequence of processes to occur such as the remote control of equipment.

This patent application relates to an earlier patent application WO 03/0980908 by the same applicant entitled System and Method for Remote Asset Management having priority date May 21, 2002. In this patent application is taught the method of managing assets remotely using intelligent endpoint wireless machine-to-machine (M2M) modules and how the captured data is processed by a remote message transaction server. This modular approach to managing assets across the wireless network translates complex proprietary system control commands at the asset into a simple language for intercommunication with the message transaction server. In one embodiment the solution makes use of Java applets which run on the remote intelligent endpoint devices which each comprise a Java Virtual Machine and customised Java libraries. A scripting tool is capable of building the asset control capability remotely and then uploading this to the wireless module connected to the asset. The management of the data-capture process according to this current data capture invention and the processing of the decoded data and any consequent process-dependent actions can be suitably performed using the system and method of this earlier patent application.

The current invention can be considered as a new and innovative technology which greatly enhances the use of this earlier remote asset management system. In particular, it is through the use of the datagram and the ubiquitous deployment of a high resolution data-capture technology, the digital camera embedded in a mobile phone or PDA, that the widespread use and versatility of this new technology can be easily adopted and exploited. Generally, data capture systems capable of driving automatic processes are known. Such general varieties include cameras for taking digital photographs which can employ image recognition software to identify elements of the photograph such as a person's face or to decode a vehicle registration number from a captured image on a service station forecourt.

Other examples of the use of captured photographic data for the automatic control of systems include systems for determining the identity of a person using biometric data such as fingerprints or palm prints and or retina scans. These systems generally process data locally and are often used to authenticate persons in order to determine that a person has right of access to a building and or access to certain zones within a building and or the access rights to use certain equipment such as computers.

Mobile operators today continue to seek new and exciting consumer services which can enhance the quality of life for which consumers are willing to pay and therefore which can drive revenue growth in the mobile telecommunications sector. The high end mobile phone or PDA device comprises powerful data processing capability as well as a high-resolution digital camera. This combined capability can be used as the means to develop new and exciting applications. In particular mobile operators of 3^{rd} generation or 3G networks are seeking unique service propositions to drive the growth of their own subscriber bases.

It is estimated that more than five million mobile phone users in the UK possess a mobile phone with a digital camera. Consequently, there exists a large installed base of mobile subscribers who already possess the capability to adopt a new lifestyle enhancing service based upon the digital camera.

As the modern information age evolves, market research data suggests that printed documentation will likely continue to play a significant part for storing and transferring data. Paper is a natural product and recycling of used paper supports the economies of scale for a paper newspaper product. In fact, the supply and demand of national newspapers and the use of public libraries are as much driven by the enjoyment of holding and reading a paper data medium, as it is to do with the demand for news stories and access to current information. In addition, the variable nature of the data content of internet-based data and news websites, which are often cluttered with adverts and which overload the webpage surfer with huge amounts of irrelevant or distracting information, often makes consulting written publications a more efficient process.

The challenge with printed media is that the information only remains current up to the moment that each page is printed. No means exist, other than by directly referring to a website or by making a phone call, for a person reading a published document to know whether the information is still current and accurate. In the instance of a published article in a technical journal, it may be that a more recent publication is now highly relevant to the reader of the said article in the light of recent scientific data or following the ruling of a government committee or industrial tribunal. Also, as soon as an article is published, it may be that the article includes an error which requires immediate correction. No versatile means yet exist to make any correction. If it were possible to easily verify the accuracy of any published information using a data capture and remote updating process, important benefits would be made available to those persons preferring to gather their information from paper media.

Travellers need touring information when visiting unfamiliar tourist destinations and many carry guidebooks which comprise stories about places of historic and scenic interest. Such publications may also include information such as travel timetables and prices and places for accommodation. Clearly such travellers would greatly benefit from a system solution which allowed them to check and verify the accuracy of travel information such as bus times and opening hours of places of interest. Also, having the means to check and verify the availability of accommodation in a certain area, which may now differ from what was published in the book, would be of great benefit to travellers and businessmen.

In other printed media areas such as in scientific journals, a technical article often includes detailed references that were used in the publication. These references require absolute accuracy for them to be of any use. A more appropriate means which could enable a reader to quickly and easily be linked to updated information about article references or further reading in a more succinct form would greatly improve existing practices of checking references and associated publications in the technical field of a publication.

In addition, readers of technical articles are often specialists having an interest in a key technical area. If it were possible to link similar references together as well as linking those references to more recent articles, a reader would be able to derive greater benefits from such documents.

In other more security-related application areas it is often essential to verify the authenticity of a person having access to certain services in a certain situation rather than at a specific location which may not directly relate to biometric data. If it were possible to gather data from a certain place to indicate that the authentic holder of a unique data acquisition device, such as a mobile phone, was at that location, then a remote data processing system could validate that certain equipment could be operated such as an entry barrier to a company car park. In this example, it is possible to imagine that the system could either operate the barrier directly or respond and send a coded message to the person at the barrier for input into a data device.

Similar requirements exist for improving the security of an Automated Teller Machine (ATM) or bank cash-point machine. There is growing concern that if a pin number can access a person's bank account, an additional layer of security such as one based upon a registered mobile phone GPRS transaction could further protect against fraudulent withdrawals by third parties.

Users of mobile phones are demanding better and more data-rich services but the cost of mobile data often makes subscribers reluctant to use such services. Currently, an important measure of market growth in the mobile telecommunications market is the Average Revenue per User (ARPU) key point indicator. While this KPI is appropriate for voice traffic, it does not support the growth of highly efficient low cost data services by the subscriber since these generate little traffic. If it were possible to create a layer of handset-based services which could simply and efficiently drive the growth of the data market, this would be very beneficial to the mobile operators.

In other situations, corporates want increased security regarding data access while needing their employees to have access to company information, which in some cases may be confidential and or strategic. If it were possible to create a service profile which controlled the use of a wireless data processing device such as a mobile phone or a PDA or a laptop comprising wireless LAN capability then this could be the basis for controlling the use of the mobile phone or PDA or laptop. This could also be a security feature. With such an innovative approach, it would then be possible to set up a differential service profile capability where different corporate employees would have their mobile phones and or PDAs and or laptops programmed with a service profile appropriate to their working needs and function within the organisation.

Often travellers in an unfamiliar town encounter a local map setting out the town layout and the shops and tourist attractions and local accommodation. If a solution existed for a tourist to easily and conveniently capture the map into their own PDA or phone which also included information within it of the details of the shops, their opening times as well as bus and train times, this would make navigating around the town much easier and more convenient.

In modern times the mobile phone is becoming increasingly adopted as the personalised intelligent device which will control access to services for each and every subscriber. The processing power of the mobile phone is such that substantially more capability can be derived from it in terms of increasing the quality of life by reducing the complexity of access to interesting or essential information.

Legislation in recent times has outlawed push-advertising such as text messages to consumers passing through base station microcells within town centres. Recommendations were made that being inundated with endless SMS advertising messages while passing through a shopping centre was unpleasant. This non-directed approach also means that most adverts would likely be of no interest to most consumers. If it were possible to create an opt-in system which was highly interesting to the consumers as well as for retailers, this would be a win-win opportunity.

Large high-street shopping chains such as Tesco and Sainsbury in the UK are ever seeking ways to increase the satisfaction of their customers and improve the quality of the shopping experience. If it were possible to further increase the loyalty of customers by providing services which benefited the shopping chain, the product supplier as well as the customer, this would increase profits as well as customer satisfaction. High street shops want to increase their customer base, food manufacturers want to increase the sales of their products while consumers want to be reassured of all their questions about foodstuffs in relation to recommended healthy daily doses of minerals, proteins, vitamins, carbohydrates and fats.

Often consumers have questions about the origin and nutrient content of certain packaged-foods within the supermarket. If a means existed to easily and efficiently check the balance of nutrients and or additives in the food, such a service would be very beneficial. A consumer might only then need to capture and communicate data to a remote data server to receive a response. In some instances, a person with a certain medical condition might want to check whether certain food additives and or even the naturally occurring substances in foods.

For example certain medications such as cyclorosporin drugs, certain calcium channel blockers and some antihistamines are affected by grapefruit juice.

Recent studies have shown that herbs such as St John's Wort, a popular herbal anti-depressant remedy, can affect the breakdown of certain drugs in the liver and therefore alter their effectiveness. The drugs that have found to be affected by St John's Wort include warfarin, digoxin, theophylline, anticonvulsants, some antidepressants, cyclosporin, HIV drugs and oral contraceptives.

Knowing whether a food contains St John's Wort (hypericum perforatum) may be very useful to a consumer. Other well known foods such as horseradish (armoracla rusticana) contain chemicals that may interfere with thyroid gland function.

In general if it were possible to check easily and conveniently whether a foodstuff contained any substances which were known to have any contra-indications for any condition or while taking a certain medication, fewer medical complications may arise. One can anticipate that a system which combined knowledge of a person's own medical condition with a reference to a particular food-stuff in question would be a further improvement and be able to provide a personal and meaningful service to check whether eating a particular food would present any challenges. Today, pharmaceutical research continues to discover new relationships between foodstuffs and the lowering in efficacy of medications when taken together by persons suffering from specific medical disorders.

In other situations, persons often wish specific information to be emailed or posted to them. This can be achieved via email or by telephone but this takes time. If a more convenient method for requesting information existed based upon a data acquisition transaction, where encoded data is forwarded to a distant IP address for example in response to a data capture and transmission process using a mobile phone camera, then this information gathering process could be made much more efficient and convenient. Through the use of a suitable registration process or via the address registered to the mobile phone user, the requested information would automatically be posted or emailed to a specific postal address or to an email address. The destination IP address or mobile phone number or landline number of the processing centre could be encoded within the encoded data.

In a separate problem area, subscribers would benefit from a system and method which could provide an efficient and convenient way to acquire destination mobile phone numbers and or IP addresses using the mobile phone camera and data processing capability of the mobile phone engine.

If this were possible, a new generation of business cards could be developed wherein a business person would show a business card whose image could be acquired and processed using the camera. This would simplify the transfer of business information.

In other areas of mobile telecommunications specialists are seeking ways to use the SIM card subscription as a means to effect commercial transactions. This creates certain liabilities for the mobile operators if they must adopt the roles of debt collectors. If there were new and secure opportunities which afforded controlled commercial transactions then this would open up the opportunity for using the mobile phone to take on a more central role in the retail process.

In a separate area there are challenges posed to companies which want to advertise in newspapers. Consumers read newspapers and may discover an interesting product for sale. Today a consumer must write down the details into a search engine or spend time surfing the web to find and download the information. If only it were possible to provide a one step process which could capture data in an advert and cause detailed preferred data to be transmitted to a predetermined email address, both advertiser and consumer would benefit. For example, estate agents often advertise in newspapers with extensive descriptions of properties for sale. If a convenient method existed for a consumer to simply ‘point and click’ a mobile device camera at a datagram alongside a property description which is subsequently transmitted to a specific IP address or phone number, this could be used to effect transmission of the sought information to an email address stored within the mobile phone or PDA.

In general, consumers are often too busy or in the wrong location when they suddenly find an interesting advert. There may not be the time or possibility to explore the capability of the product. Quite likely many sales are lost because details of adverts and how to locate or order a product are forgotten in this way.

In the retail sector the software gaming industry is seeking more efficient and more secure methods for providing software products to consumers. If it were possible to provide a method which would enable consumers to order software to be sent to computer email addresses by way of a registered device which was directly linked to a charging and billing system, software outlets would not need to carry any product.

In music stores, consumers are often told that some music is no longer available or needs to be ordered. If it were possible to compile bespoke music CDs from an archive of music stored on a central server, then a new level of music CD creation service would be possible. A consumer would only need to select the datagrams of sought music from an archive and these would then be downloaded and burned onto a CD.

Often, music concerts are advertised in newspapers indicating times and locations and ticket prices. If a more convenient method existed based upon encoded datagrams published alongside the advertised music concert using a secure mobile phone-based transaction, then this would be much appreciated by consumers for ordering tickets.

In other areas of advertising such as in fashion magazines, a consumer may be highly interested in knowing the price of a desirable dress or jacket or piece of jewellery. If it were possible to simply and discretely ‘point and click’ using a mobile phone or PDA with a camera which resulted in details being emailed to a personal email address, this could prove very beneficial for both retailer and consumer. Similar benefits would accrue for persons visiting art galleries or exhibitions or consumer goods shops such as those selling electronic equipment where receiving the technical specification may be highly desirable.

Wherever consumers go there is also a large amount of legal information such as forms to fill in and rules and regulations which are often confusing to understand. Consumers would equally benefit from services which could provide detailed information in the right format—such as published in the right language—if these documents could also be accessed by a simple ‘point and click’ service.

Further to the limitations of existing methods used for enhancing data security and data access and data validation; and so far as is known, no optimum system and method for data acquisition and processing is presently available which is directed towards the specific needs of this problem area as outlined.

### OBJECTS OF THE INVENTION

Accordingly, it is an object of the present invention to provide an improved system and method for data acquisition and processing which serves to capture and or process specific encoded information and transmit the information, or the data extracted from it, to a local and or to a remote database.

It is a further object of one embodiment of the present invention to provide a system and method for data acquisition and processing which serves to capture and or process specific encoded visual information and transmit the information, or the data extracted from it, to a local and or to a remote database.

It is a further object of one embodiment of the present invention to provide a system and method for data acquisition and processing which is applicable to wireless device technology such as a mobile phone or PDA or laptop wherein each is linked with centralised and or distributed and or remote data processing resources.

It is a further object of one embodiment of the present invention to provide a system and method for data acquisition and processing wherein a device comprises a visual data capture system which is used to capture one or more structured images or datagrams which are encoded according to a predetermined format.

It is a further object of one embodiment of the present invention to provide a system and method for data acquisition and processing which comprises a visual data capture system for capturing one or more structured images encoded according to a predetermined format and wherein said images comprise geometric shapes and or gridlines and or alphanumeric symbols and or other language characters and or custom-made images which convert into a standard message format either within the data acquisition device itself or at a remote server.

It is a further object of one embodiment of the present invention to provide a system and method for data acquisition and processing wherein captured structured images encoded according to a predetermined format may be transmitted by wireless or fixed wire connection to a data processing centre in order to be decoded and wherein the decoding process may cause one of a plurality of different actions to occur.

It is a further object of one embodiment of the present invention to provide a system and method for data acquisition and processing wherein captured structured images encoded according to a predetermined format may be transmitted by wireless or fixed wire connection to a data processing centre in order to be decoded and wherein the decoding process may drive processes to control or operate equipment either locally or remotely.

It is a further object of one embodiment of the present invention to provide a system and method for data acquisition and processing wherein captured structured images encoded according to a predetermined format may be transmitted to a data processing centre for decoding and wherein the decoding process may subsequently cause the return of messages back to the data acquisition device and or the transmission of data-rich information to specific IP addresses such as email addresses and or GPRS devices and or 3G devices and or web sites.

It is a further object of one embodiment of the present invention to provide a system and method for data acquisition and processing wherein captured structured images encoded according to a predetermined format may be transmitted to a data processing centre to be decoded and wherein the decoding process may cause the return of messages back to the data acquisition device to modify the functionality of the data acquisition device and or the operation of equipment in the vicinity of the data acquisition device.

It is a further object of one embodiment of the present invention to provide a system and method for data acquisition and processing wherein captured structured images encoded according to a predetermined format may be transmitted to a data processing centre to be decoded and wherein the decoding process may provide authentication and authorisation such as to allow building access and or car park access.

It is a further object of one embodiment of the present invention to provide a system and method for data acquisition and processing wherein captured structured images encoded according to a predetermined format may be transmitted to a data processing centre to be decoded and wherein the decoding process may provide authentication and authorisation of the holder of the data acquisition device and thereby permit access to one or more services.

It is a further object of one embodiment of the present invention to provide a system and method for data acquisition and processing wherein captured structured images are encoded onto a printed page or publication and alongside data with which the said structured image is to be associated and wherein the data capture process thereby provides the means to generate a data update request based upon the published information and or to facilitate the versatile access to data rich services based on the published information which may be directed back to the data acquisition device itself or sent to a predetermined IP or email address.

It is a further object of one embodiment of the present invention to provide a system and method for data acquisition and processing wherein captured structured images are encoded into travel guides to verify current timetables and or prices and or accommodation information and the like.

It is a further object of one embodiment of the present invention to provide a system and method for data acquisition and processing wherein captured structured images are encoded into travel guides to update dynamic information so that the travel guide remains valuable and usable for its static content such as places to visit and extensive historical detail and the like.

It is a further object of one embodiment of the present invention to provide a system and method for data acquisition and processing wherein captured structured images are encoded onto food and or drink and or medication packaging so that consumers can request more information about the contents of the food and or request medical contra-indication information which may be directly linked to a pre-registered or predetermined medical condition and or dietary requirement.

It is a further object of one embodiment of the present invention to provide a system and method for data acquisition and processing wherein foodstuffs would be encoded with structured images and thereby enable consumers to interrogate the origin of different products and or to generate answers in accordance with a predetermined list of standard format questions such as energy content, whether the product contains nuts, the level and types of fats present, the nutritious value and the like.

It is a further object of one embodiment of the present invention to provide a system and method for data acquisition and processing wherein captured structured images are encoded into technical journals in order to facilitate the updating of information and or the ease of cross-referencing the publication with any relevant articles published in the field and whereby data rich articles can be automatically generated and forwarded to pre-registered IP and or email addresses and or websites.

It is a further object of one embodiment of the present invention to provide a system and method for data acquisition and processing wherein captured structured images or datagrams may be processed by a specific data processing server so that the data can be compared with current source data and dynamically updated as required to thereby replace or enhance any published information associated with the said structured image or datagram.

It is a further object of one embodiment of the present invention to provide a system and method for data acquisition and processing wherein structured images or datagrams are pre-programmed or programmed into data-acquisition devices such as mobile phones and or PDA type devices and or laptop computers, either locally or remotely, and either before use or while in use, such that the user of the data acquisition device may receive changes and or enhancements to available services.

It is a further object of one embodiment of the present invention to provide a system and method for data acquisition and processing wherein structured images or datagrams are pre-programmed or programmed into data-acquisition devices such as mobile phones and or PDA type devices and or laptop computers, which are to be used by employees in a corporate environment and wherein each employee can be provided with a function-specific service portfolio according to his work function.

It is a further object of one embodiment of the present invention to provide a system and method for data acquisition and processing wherein structured images or datagrams are pre-programmed or programmed into data-acquisition devices such as mobile phones and or PDA type devices and or laptop computers, which is applicable to employees in a corporate environment and wherein an employee can be provided with a uniquely encoded and thereby secure function-specific service portfolio and wherein an employee can be provided with a controlled access to corporate services and databases.

It is a further object of one embodiment of the present invention to provide a system and method for data acquisition and processing wherein captured structured images or datagrams are encoded alongside geographical addresses such that acquisition and transmission of the structured image or of data associated with the structured image and decoding of the structured image, or associated data, may result in receipt of geographical information such as a map of the subscriber's current location.

It is a further object of one embodiment of the present invention to provide a system and method for data acquisition and processing wherein one or more structured images or datagrams are encoded into geographical maps wherein each is associated with different types of information such as public transport timetables, accommodation facilities, public services and the like.

It is a further object of one embodiment of the present invention to provide a system and method for data acquisition and processing wherein the capturing and processing of structured images or datagrams may be associated with mobile phone services and linked and charged to the mobile phone subscription for that device.

It is a further object of one embodiment of the present invention to provide a system and method for data acquisition and processing wherein the capturing and processing of structured images or datagrams may result in the generation of confidential information and whereby this information is forwarded to a secure IP address such as an email account.

It is a further object of one embodiment of the present invention to provide a system and method for data acquisition and processing wherein the data capturing device may be programmed with specific decoding algorithms to enable certain devices to decode secure datagrams while rendering the same datagrams meaningless to devices not possessing a said specific decoding algorithm. In this way additional levels of security are created for access to and the enabling of specific services.

It is a further object of one embodiment of the present invention to provide a system and method for data acquisition and processing wherein the data capturing device may be programmed with specific decoding algorithms in accordance with a specific level of subscription service and or security clearance.

It is a further object of one embodiment of the present invention to provide a system and method for data acquisition and processing which may be linked to a service to generate data-rich content having few or no adverts in accordance with specific levels of subscription and wherein low cost or free services may be provided in return for receipt of data which includes a certain level of advertising content.

It is a further object of one embodiment of the present invention to provide a system and method for data acquisition and processing which may be linked to a service to generate data-rich content having few or no adverts in accordance with specific levels of subscription wherein subscribers would benefit from a greatly improved data service in accordance with specific needs and or in a specific language and or format.

It is a further object of one embodiment of the present invention to provide a system and method for data acquisition and processing which may be linked to free or low cost data access services wherein the combination of user profiles and the type of data access requested may be used to target advertising content to consumers and thereby enhancing the business effectiveness of the advertising.

It is a further object of one embodiment of the present invention to provide a system and method for data acquisition and processing which is highly suitable for generating content-rich data access services and which is highly suitable to broadband wireless devices such as GPRS, 3G, WLAN, and 4G devices.

It is a further object of one embodiment of the present invention to provide a system and method for data acquisition and processing by a wireless device which may be used to capture a structured encoded image or datagram from the electronic screen of a computer terminal or LCD screen or television screen and thereby be used to access additional data appropriate to the access privileges and or requirements of the data capture device.

It is a further object of one embodiment of the present invention to provide a system and method for data acquisition and processing by a wireless device which may be used to capture a structured encoded image or datagram from an electronic or LCD screen or the like wherein an encoded icon or datagram may be generated on the display of an in-vehicle radio receiver and whereby the simple visual capture and processing of this datagram may result in directions as a function of the current geographic coordinate as provided by the GPS equipment of the vehicle and wherein directions are given in response to an emergency situation or to traffic congestion or to a delivery request and the like.

It is a further object of one embodiment of the present invention to provide a system and method for data acquisition and processing which is linked to a mobile subscription service level profile such that a user may be granted access to company car parks in response to the local or remote processing of an encoded datagram such as may be displayed alongside the car park barrier and thereby granting free access or charging access to the holder of the subscription in accordance with the level of the said profile.

It is a further object of one embodiment of the present invention to provide a system and method for data acquisition and processing which generates a level of security for a wireless device and grants different service profiles in accordance with the role of an employee.

It is a further object of one embodiment of the present invention to provide a system and method for data acquisition and processing wherein the encoded image comprises an associated phone number and or email address and or IP address and which the data capture device such as the mobile phone can process and automatically decode. In this way, ‘direct IP links’ or encoded mobile phone numbers to specific data processing services can be encoded within the image and whereby no input is required by the subscriber or user of the data capture device.

It is a further object of one embodiment of the present invention to provide a system and method for data acquisition and processing wherein the invention is applied to create a new generation of business enhancement services wherein a new type of business card can be envisaged comprising a datagram encoded with personal information such as email addresses, phone numbers and corporate information and wherein a person would show a business card whose image could be acquired and processed using the camera alone either for automatic transmission within the phone for future use and or for transmission to a remote storage device.

It is a further object of one embodiment of the present invention to provide a system and method for data acquisition and processing wherein the invention is applied to create a new generation of business enhancement services wherein the capture of an encoded datagram might be associated with a sound byte when received such as a person's name and wherein voice recognition software may be used subsequently to generate access to the person's details.

It is a further object of one embodiment of the present invention to provide a system and method for data acquisition and processing which has direct application to retail transactions whereby a consumer may capture a datagram associated with a software product using a data capture device with a subscription linked to a charging and billing system such that a secure web link is forwarded to the user's email address or the software itself is sent to an email address. In this way a retail store need not stock a software product but just display posters showing still images of the games and the datagram. The transaction is made secure by encoding the software in a way that it only runs with reference to a hardware configuration of the computer or gaming terminal to where it is downloaded or with reference to the SIM card of a mobile phone.

It is a further object of one embodiment of the present invention to provide a system and method for data acquisition and processing which has direct application to enhance the effectiveness of advertising in newspapers and journals and magazines and the like. Datagrams published alongside adverts can be captured and processed by a mobile phone or PDA and then cause detailed information to be automatically forwarded to a pre-registered email address or IP address stored in the phone. This email address or IP address is automatically added to the data message which is transmitted to the advertiser. In this way busy consumers only need to ‘point and click’ and the decoded datagram causes the sought information to be sent to the consumers email address or IP address.

It is a further object of one embodiment of the present invention to provide a system and method for data acquisition and processing which has direct application to high-street shopping chains as a means to improve customer service and thereby increase customer loyalty.

It is a further object of one embodiment of the present invention to provide a system and method for data acquisition and processing which has direct application to improve the consumer experience when visiting car show rooms by providing information in response to capturing a datagram which extends to comprehensive details of points of sale for a product such as 2^{nd} hand car sales and current privately advertised vehicles.

It is a further object of one embodiment of the present invention to provide a system and method for data acquisition and processing which has direct application to music retail where bespoke music CDs can be compiled with relation to a remote music archive and where the music store is then able to is provide a personal music service and not limited to the CD collection on display in the shop.

It is a further object of one embodiment of the present invention to provide a system and method for data acquisition and processing which has direct application to the ordering of tickets from adverts published in newspapers where datagrams are published alongside the adverts so that consumers can directly order tickets and have them charged and despatched using this point and click method.

It is a further object of one embodiment of the present invention to provide a system and method for data acquisition and processing which has direct application to requesting information about published fashion articles and have this emailed to a personal email address stored within the mobile device.

It is a further object of one embodiment of the present invention to provide a system and method for data acquisition and processing which can be applied in public council offices to facilitate the acquisition of information and legal forms in the right language. In this way persons can more easily acquire documents that they need to complete and despatch.

Other objects and advantages of this invention will become apparent from the description to follow when read in conjunction with the accompanying drawings.

### BRIEF SUMMARY OF THE INVENTION

Certain of the foregoing and related objects are readily-attained according to the present invention by the provision of a novel system and method for data acquisition and processing which can form the basis of a new and exciting portfolio of mobile telecommunications business and consumer services. The diverse nature of the services offers a radical improvement in the quality of life of consumers.

The data acquisition method enables a wireless subscriber to access data based upon the capture and processing of an encoded image, either by the data acquisition device itself and or by a remote data processing centre. The data acquisition device may itself be programmed with a service level profile in accordance to the status and or work function of the subscriber and thereby determine the level of data content that may be accessed or the format and destination where a data response is to be forwarded such as to an email address or IP address.

The data acquisition process may be directly linked to the use and activation of machinery and or building access and or car park access. In certain situations the access may be further linked to a level of payment for access to a car park which may be charged directly to the subscription holder of the data access device.

In essence the invention provides the means to update printed and or published information by providing a user with additional data in return such as any changes to public transport times when the datagram alongside a timetable is processed.

The invention further lends itself to a wide application of examples for cross referencing data in relation to predefined subscriber profiles such as for example with those containing personal dietary and health data so that a consumer may interrogate and process the contents of a foodstuff and thereby receive reassurance whether a foodstuff may present any health risks if eaten.

The system accommodates all forms of image encoding which may be suitably processed by mobile phone digital cameras. The datagrams may be created according to specific standardised formats wherein industry segments may define the meaning of elements of datagram types. In addition, as a means to enhance security, corporates may develop their own customised datagrams which will provide corporate-secure access to services wherein corporate mobile devices may comprise specific image translation algorithms. In this way corporate services remain accessible only to corporate employees.

As a means to improve communication efficiencies, the destination IP address or mobile phone number or email address to which data is to be sent may be encoded into the datagram. In this way there is no need to key in a certain IP address of a data server which may be too complex in many consumer applications.

Other objects and features of the present invention will become apparent from the following detailed description considered in connection with the accompanying drawings, which disclose several key embodiments of the invention. It is to be understood, however, that the drawings are designed for the purpose of illustration only and that the particular description of the data acquisition process and the suggested encoded datagrams are given by way of example only and do not limit the scope of the invention.

### BRIEF DESCRIPTION OF THE DRAWINGS

FIG. 1 illustrates a schematic of the sequence of actions of the data acquisition process according to a first embodiment of the invention.

FIG. 2 illustrates a schematic of the sequence of actions performed by a remote data processing server upon receipt of a data service request according to the current invention.

FIG. 3 illustrates three examples of encoded structured images which may be used in accordance with the current invention.

### DESCRIPTION OF A PREFERRED EMBODIMENT

Reference will now be made in detail to some specific embodiments of the invention including the best modes contemplated by the inventor for carrying out the invention. Examples of these specific embodiments are illustrated in the accompanying drawings. While the invention is described in conjunction with these specific embodiments, it will be understood that it is not intended to limit the invention to the described embodiments. On the contrary, it is intended to cover alternatives, modifications, and equivalents as defined by the appended claims. The following description makes full reference to the detailed features as outlined in the objects of the invention.

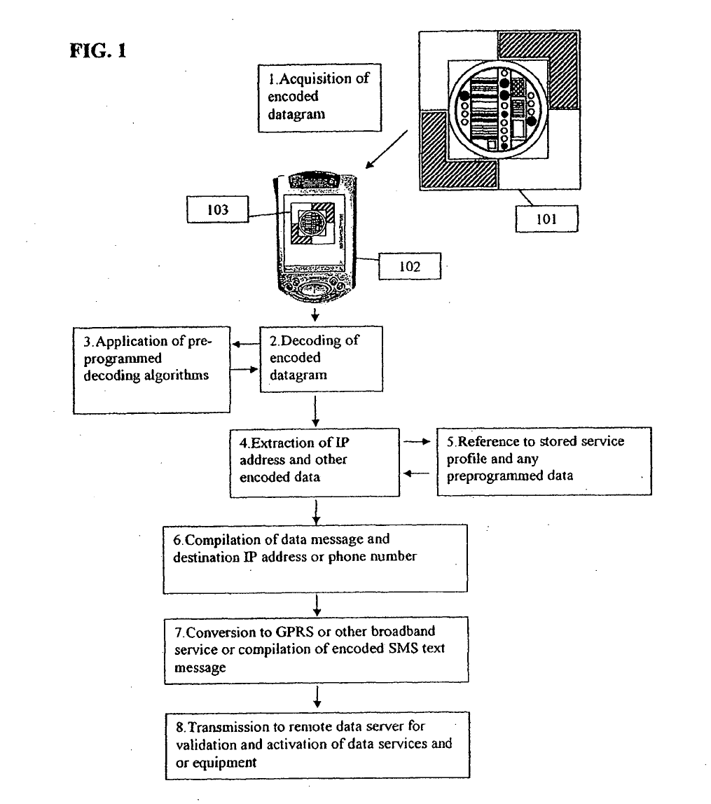

Referring now in detail to the drawings and in particular FIG. 1 thereof, therein illustrated is a schematic of one example showing the sequence of actions of the data acquisition process. Such a method could be used to access data rich services or to enable the activation of local machinery or to enable building access.

In the figure is shown one example of an encoded structured image or datagram (101) and a data acquisition device (102). In this example a PDA is used. The sequence of steps is numbered within the text boxes.

In the first step the user takes a photograph of the datagram which comprises elements to help centre the datagram within the screen. For example, the shaded corned areas may indicate the orientation of the datagram and the combination of circles and squares may define the data-containing field. All manner of visual encoding may be used which may be easily and efficiently captured and decoded by the data capture device. In this example different sequences of circular elements and geometrical shapes and barcode lines are shown.

The captured image (103) is then displayed upon the screen of the data capture device. Within the data capture device the encoded datagram is decoded (step 2) and one or more pre-programmed decoding algorithms are applied (step 3). According to different applications, different levels of data access and different types of data may be determined by one or more of these decoding algorithms. For example, a first level of decoding algorithm may extract a first level of data such as an IP address or phone number while higher level decoding algorithms may extract more data from the datagram itself.

The resultant decoding produces a dataset including a destination IP address or phone number and any other encoded data (step 4).

The invention provides for data access and service access according to different service profiles such that free or low cost services may be provided which will include targeted advertising content while higher paid service profiles will access data-rich services with no advertising. Before compilation of the data message to the data processing server, reference may be made to any stored service profile and or any pre-programmed data (step 5).

In accordance with different applications such as for verifying if there are any contra-indications of the ingredients of any food or drink as published on the packaging in terms of a datagram, the data acquisition device may be pre-programmed with personal data such as a medical condition or allergy or the like. In such an application, reference may be made to any stored personal data (step 5) to enable comprehensive comparison with the food. Ingredients and whether the contents pose any complications.

Following decoding of the datagram and extraction of the destination IP address and or email address and or mobile phone number, and following reference to any stored data and or any service level profile an appropriate data message is compiled (step 6). The message may then be encoded for transmission such as by GPRS or by 3G or by WLAN or any appropriate broadband service. It is also anticipated that the datagram may be decoded by the data acquisition device itself and compiled into the format of an SMS text message (step 7).

In this embodiment of the invention, following data capture and processing according to any pre-programmed decoding algorithms and any reference to a stored service profile and or personal data, the data message is transmitted to the IP address or email address or phone number extracted from the data message or extracted from the memory of the data acquisition device itself (step 8).

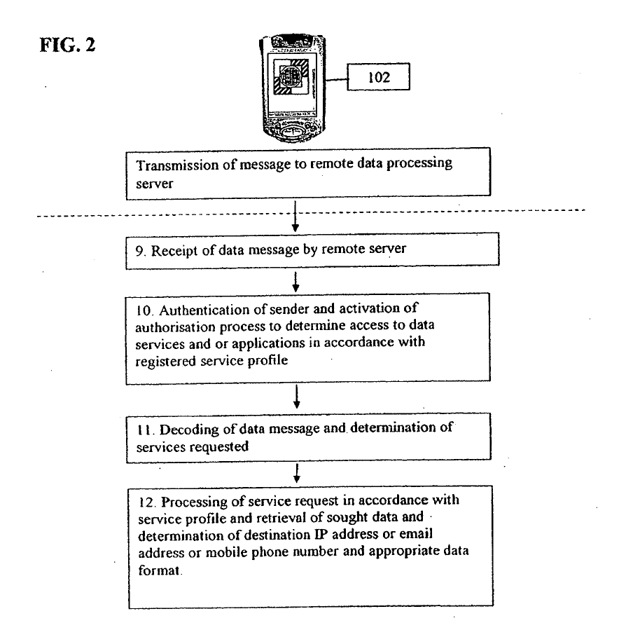

Now with reference to FIG. 2 is shown one embodiment of the sequence of processing steps performed by a remote data processing centre.

After the data capture device has processed the encoded image or datagram the message is transmitted to a data processing centre.

The data message is received by the remote server (step 9). After this, the authentication of the sending device is determined as well as the authorisation to access data services in accordance with any registered service profile (step 10). Following authentication and authorisation, the data access request is decoded and the types of services requested are determined (step 11).

The service request is then processed and data services are provided and forwarded to a specific IP address or mobile phone number or email address in accordance with the request. If data is requested to be sent to the data capture device itself, the date will be compiled into the appropriate data format (step 12).

In this sequence of data processing steps as performed by the data processing centre, it is also anticipated that the services may include activation of specific systems or equipment such as a car park barrier or a building access door.

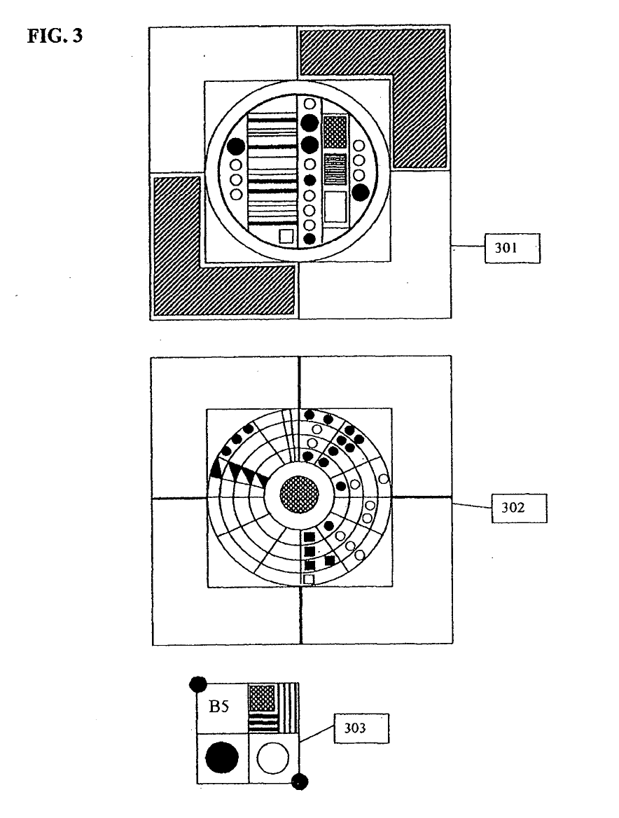

With reference now to FIG. 3 are shown three examples of simple encoded image datagrams (301, 302, and 303). Each datagram is built up of geometrical elements which are arranged according to some predetermined format so that a remote data processing centre is able to decode the information associated with the image.

Datagrams (301 and 302) are examples of complex data-rich datagrams which might be associated with a range of services and interpreted by the data capture device in different ways according to a predefined service profile stored in the data capture device. Datagram (303) is a simple encoded image which may be to used on food packaging where only a destination IP address and product identification may be required.

All manner of encoding may be used such as predetermined patterns of geometric shapes and gridlines and or alphanumeric symbols or other language characters such as Korean or Chinese characters.

The range of possible datagram encoding is very large and may extend to stylish designer datagrams including proprietary encoding requiring specific decoding algorithms. This offers an additional level of security which can control access to services. For example, corporates may develop their own datagrams which can only be decoded by employees.

The system and method will make use of all known types of data encoding and data processing. In a preferred embodiment, the transmission of the data to the destination data processing server may be embedded into the encoded image itself such that the data acquisition process decodes the destination IP address. In this way no additional input is required by the user as to where the data should be sent. This is a key aspect of the invention that a user no longer needs to key in any destination phone number or IP address.

In the context of the level of service, 3G broadband networks offer the capability for rich services and the transmission of quite complex images and or a sequence of images in a single message. A certain service level profile may involve the decoding and transmission of the datagram itself, while a lower level of service profile may transcode the image into a sequence of alphanumeric characters and transmit these using GPRS or SMS text message. In this way, the access to the data enhancement services may be made using all forms of air-interface technology such as GSM and HSCSD. It can be understood that the level of processing capability of the data capture device determines the levels of service available to the subscriber.

The invention is also suited to alternative environments where WLAN or VOIP communication systems are in operation. Some mobile operators and Internet Service Providers offer such networks and this application makes possible a range of services to complement the growth of subscribers or users of these services. A solution using WLAN or VOIP or WIMAX or Wireless USB or a combination of these wireless technologies offers the possibility to build solutions with high integration capability with existing fixed and wireless networks which can be operated at low cost.

The implementation of the invention will now be described with relation to the data acquisition device. All types of software solution may be used to implement the invention on a wireless device. For example, the mobile phone application which will link the use of the optical camera with specific functionality of the phone may be written in lava such as Java2 Micro-edition (J2ME/CLDC) and ported to the device. The application will run on any data capture device which possesses a Java runtime environment or Java virtual machine.

This application may be seamlessly integrated into the menu driven SW of the mobile phone. The user then simply activates the application using the menu system which will direct the user to capture a datagram.

The data capture application will be linked to specific data stored in the mobile phone memory such as a service level profile. This may be used to determine the level of service and the range of services available to the subscriber. The menu system will direct the subscriber to capture an image which is then processed with reference to the service level profile and any decoding algorithms which may be needed for decoding the datagram image.

The application will comprise the facility to receive service profiles from a data centre or the user may be directed to enter specific coded information. Additionally, the user may enter an email address or IP address where specific data services are to be linked in the instance that data is to be sent to a home email address.

When in use, the software application will verify to the user that the image has been successfully captured and that the destination email address or IP address or phone number encoded within the datagram image has been determined. The subscriber may be given the opportunity to press SEND to transmit the extracted data message for access to the service sought or the transmit function may be automatic for convenience.

Since the data capture device has the processing capability to extract the destination IP address or mobile phone number or email address it may be more appropriate that the data capture process automatically extracts and sends the data to the remote server for processing.

Applications

One can envisage a vast range of services based upon this inventive system and method. The following list set out a non-limiting list of possible applications.

In a restaurant for example, and in other customer service applications, patrons might make use of image capture from datagrams printed in menus and using transmission over a free network to more efficiently request service or report their choices to the kitchen.

In an alternative embodiment, encoded images or datagrams may be used to program devices without requiring the need for transmission of data using wireless systems. Encoded datagrams may comprise computer upgrade instructions so that the data acquisition device may also be directly programmed by graphical information. This inventive method has direct application to gaming consoles whereby different gaming features may be introduced into a game via a data capture device associated with the gaming console itself or attached to the computer system running the game. Such a method provides additional diversity in the game without requiring the use of memory storage media.

In this application, custom encoded images are created specifically for the game itself which may only have relevance to the gaming software when decoded by the games console.

It is equally envisaged that published adverts may include encoded datagrams so that consumers may access services and information in accordance with their needs and desires. Published competitions may also be based upon a standard format of printed datagram where entry into the competition is simplified by the ‘point and click’ method. If the data capture device has 3G or broadband capability, the subscriber may receive a dynamic and colourful high-resolution graphic sent back to the phone itself.

This innovation has further efficient application to business cards wherein the card is encoded with a datagram comprising phone numbers and email addresses and corporate websites such that a simple ‘point and click’ data capture method using the mobile phone camera makes possible instantaneous acquisition of essential data. This approach lends itself to business persons carrying a single permanent business card with the appropriate surface texture for optimum image capture.

The data acquisition method may also be applied to active optical systems whereby encoded images are read by fixed cameras which decode the image and cause data to be sent to an IP address encoded within the image. This reverse application of the invention can also provide an automatic card reader and system activation service which has direct application to door access systems, car park access systems, machinery operation systems and the like.

In one embodiment of this application, a user wishing to gain building access would display an encoded datagram in front of an active camera. Such a datagram may be unique and printed on a single security ID card incorporating a specific surface texture required by that data capture device to read the datagram. The decoding of the datagram would enable a building monitoring system to determine whether a person may be given access.

In the application of this solution to a car park, a driver will display a datagram by a car park barrier and the data capture system would be able to verify that a person may be granted free access and or be allowed to enter subject to being billed to a pre-registered subscription.

In alternative environments the data captured may not comprise visual information. It is equally anticipated that in certain security applications or in system monitoring applications the data encoding may also or alternatively comprise an encoded sequence of sounds in the audible or ultrasound range. Such an application could monitor an environment comprising fixed equipment. Encoded sequences of sounds could comprise destination IP addresses or email addresses or mobile phone numbers of service engineers as well as equipment ID and status data such that a data capture device could monitor the environment and determine the status of particular piece of equipment in accordance with its operation. It may be that some environments are required to be shielded from electromagnetic fields in which case monitoring of the equipment may take place using a fixed line data capture device pre-programmed to capture and decode ultrasound transmissions.

In computer games retail, a consumer captures the image of a datagram published beside still images of a game in a games magazine or sees posters on the wall of a games retail store. This image is processed and transmitted to a remote data server associated with the game. Specific data to authenticate the consumer performing the transaction such as details associated with the owner of the subscription of the PDA, or mobile phone used to capture the image is also forwarded. If the game is a mobile phone game then the game is sent directly back to the mobile phone using a broadband connection. If the game is for a home PC or games console then the transaction causes a web link to be forwarded to an appropriate email address registered to the consumer. This then provides the method for the consumer to access and download the game later and no product need to be provided in the retail store.

Based upon this application of the invention it is quite easy to understand the application to consumer competitions such as is found in newspapers and magazines and the like. In the competition application, a consumer might capture, decode and transmit a data message to a distant server and receive, in return confirmation of entry in a competition. If a payment is required such as for a National Lottery, this payment can be charged to the subscription. Other competition formats may comprise free entry into a competition using the datagram capture method and whereby in return advertising information is sent to a pre registered email address.

The following additional business applications are listed to clarify the advantages of this system and method when utilised in a simple ‘point and click’ mode to enhance the users' experience, particularly with regard to the ease of receiving directed and personalised information:
1. Secure transactions for purchasing goods and services
2. Unpaid services requesting data on a product or service, or services requesting public documents
3. Unpaid services granting access to competitions in exchange for advertising
4. Unpaid services for providing data about mortgages, bank services, and wills and testaments
5. Unpaid services providing educational information on sought subjects.

This invention provides a paradigm shift in the mobile phone messaging world. The range of new data services and transactions that this technology can provide is quite phenomenal. While Google and other search engine companies offer a first level of data searching capability based upon entering specific key words, this invention extends the searching phenomenon by creating the impetus for companies to pre-format information and send it to consumers who by virtue of the ‘point and click’ method are already demanding it.

The invention provides advertisers and retailers with a clientele who by virtue of the data capture process, opt-in to receiving data. This provides exciting opportunities for linking consumers with more directed advertising campaigns.

The invention, with the use of datagrams and application software for differentially decoding the datagrams according to the nature of the services sought, provides the very means to avoid typing in a mobile number or an IP address because this is already encoded within and extracted from the datagram automatically.

In a car sales show room, a potential customer interested in a certain car may use the invention to register interest in a model using the ‘point and click’ method to capture a datagram from a magazine or adjacent to a vehicle in a car showroom. The customer's email address is sent with the data message who subsequently receives detailed information about the vehicle, availability of 2^{nd} hand vehicles and links to privately advertised vehicles in the local newspapers relative to his home and or current location.

In music and video stores, consumers can capture datagrams from catalogues of published music or video tracks using a mobile device or with a system dedicated to the shop which does not use the mobile network. This device could utilise wireless USB. In this way personalised music compilations or favourite TV programs and old black and white films could be accessed from a local or remote archive and burned onto CD or DVD. In this way the store does not need to carry product inventory and can more suitably serve its market.

Newspapers and magazines and posters carrying adverts for concerts and other events could also publish ticket-order datagrams whereby the mobile phone may be used to effect a secure mobile phone-based transaction.

The datagram and the use of the mobile phone as an intelligent device will transform the way retailers can reach out to their market. Magazines could advertise product with datagrams and thus enable consumers to receive detailed information about product pricing and availability.

As described above, the present invention of the system and method for data acquisition and processing has widespread application to enhance the quality of life and may be implemented in diverse forms. It should be understood however, that the present disclosure is for the purpose of illustration only and does not include all modifications or improvements, which will become obvious to the man skilled in the art in the light of this publication which may fall within the scope of the appended claims.

1. A method for fixed or wireless image-initiated service-access via a remote server platform characterised by the steps of:
a. capturing an encoded image or datagram (101) by a data acquisition device (102) and displaying said captured image upon the screen (103) of said data acquisition device (102) wherein
said encoded image being on a paper sheet or vinyl sheet or a billboard or an electronic screen of a computer terminal or LCD screen or television screen and displaying said captured image upon the screen (103), and
said data acquisition device being a mobile phone or a PDA or a multimedia computer and further comprising pre-programmed decoding and/or encoding and/or formatting software according to a stored dataset comprising a user service profile for accessing one or a plurality of services by means of a transactional applications link to a service portal wherein said service portal further comprising a retail payment portal and/or a phone portal and/or a data access portal at said remote server, and
said encoded image or datagram (101) comprising one or a plurality of data-containing fields being in a complex graphical object integrated within an image, and/or predetermined patterns of geometric shapes and/or gridlines and/or barcodes and/or alphanumeric symbols.

2. A method for fixed or wireless image-initiated service-access via a remote server platform as disclosed in claim 1 further comprising the steps of:
b. decoding at least part of said encoded image or datagram (101) within said data acquisition device (102) by applying one or a plurality of said pre-programmed decoding and/or formatting algorithms, wherein different levels of service access and different types of data may be determined according to one or a plurality of different applications,
c. producing a dataset including a destination IP address and/or a phone number and/or an Email address, and further including other encoded data, wherein part of said encoded data comprising references to one or a plurality of stored service profiles, wherein said references further comprising personal data,
d. compiling a data message wherein said message being encoded for transmission by GPRS and/or by 3G and/or by WLAN and/or into the format of an SMS text message, and/or an MMS message, and/or over wireless XML, and/or via BlueTooth and/or via wireless USB, and/or via RFID
e. transmitting said data message to said IP address or Email address or phone number of a remote data processing centre, wherein said IP address or Email address or phone number being either extracted from the memory of said data acquisition device or decoded from said encoded image or datagram (101).

3. A method for fixed or wireless image-initiated service-access via a remote server platform as disclosed in claim 2 further comprising the steps of:
f. receiving said data message by said remote data processing centre at said remote server,
authenticating said sending device,
determining the authorisation to access specific services from said remote service portal at said remote server in accordance with said registered service profiles,
decoding the data access request and determining the types of services requested,
g. processing said data service request,
providing access to said data service and/or application and/or said requested information in accordance with said service profile,
processing said authorised service request,
h. compiling said requested information data into the appropriate data format,
forwarding said requested information data to a specific IP address and/or mobile phone number and/or Email address in accordance with said request, and/or sending said requested data back to said data acquisition device (102).

4. A method for fixed or wireless image-initiated service-access via a remote server platform according to claim 3 wherein when said data acquisition device does not comprise a pre-stored transactional application in said step a, said step a. being preceded by the steps of:
i. sending an SMS or EMS or MMS message to a predetermined number of said remote server, or sending a local BlueTooth transmission, or local RFID transmission to a local receiver being linked to said remote server, associated with said encoded image in order to request said remote server for a download of said decoding and/or encoding and/or formatting software for accessing one or a plurality of basic services by means of a transactional applications link,
j. receiving a download application, wherein said download application self-installing within said data acquisition device.

5. A system for fixed or wireless image-initiated service-access via a remote server platform characterised by:
a data acquisition device (102) comprising means for capturing an encoded image or datagram (101) wherein said data acquisition device being a mobile phone or a PDA or a multimedia computer and further comprising pre-programmed decoding and/or encoding and/or formatting software according to a stored dataset comprising a stored user service profile for accessing one or a plurality of services by means of a transactional applications link to a service portal wherein said service portal further comprising a retail payment portal and/or a phone portal and/or a data access portal at said remote server.

6. A system for fixed or wireless image-initiated service-access via a remote server platform according to claim 5 wherein:
said data acquisition device comprising means for decoding said encoded image or datagram (101) and producing a dataset including a destination IP address and/or a phone number and/or an Email address, and further including other encoded data, wherein
part of said encoded data comprising references to one or a plurality of said stored service profiles, wherein said references further comprising personal data and means for transmitting said data message to said IP address or Email address or phone number of a remote data processing centre, either extracted from the memory of said data acquisition device (102) or decoded from said encoded image or datagram (101) in the form of a service request based upon one of a plurality of different service profiles to said remote server platform, and
said encoded image or datagram (101) comprising one or a plurality of data-containing fields being in a complex graphical object integrated within an image, and/or predetermined patterns of geometric shapes and/or gridlines and/or barcodes and/or alphanumeric symbols.

7. A system for fixed or wireless image-initiated service-access via a remote server platform as disclosed in claim 6 wherein:
said remote data processing centre further comprising means for receiving, authenticating and determining the authorised requested service or application, and means for executing said service or application from said service portal at said remote server platform and
further comprising means for compiling the formatting and sending information data to a specific IP address and/or mobile phone number and/or Email address in accordance with said request, and/or sending said requested data back to said data acquisition device (102).

8. A system for fixed or wireless image-initiated service-access via a remote server platform according to claim 5 wherein when said data acquisition device does not comprise a pre-stored transactional application, a transactional application is installed by a user on said data acquisition device (102) either
by sending a SMS or EMS or MMS message to a predetermined number or IP address, of said remote server, or over a local BlueTooth link via a local receiver, or over an RFID link via a local receiver to said remote server, to a number or IP address associated with said encoded image in order to request said remote server for a download of said decoding and/or encoding and/or formatting software for accessing one or a plurality of basic services by means of a transactional applications link, and receiving a basic download application, wherein said basic download application self-installing within said data acquisition device, or
by paying a subscription for a higher service profile for accessing one or a plurality of services by means of said transactional applications link, and receiving one or a plurality of application packages being downloaded by said remote server comprising said decoding and/or encoding and/or formatting software.

9. A system for fixed or wireless image-initiated service-access via a remote server platform as disclosed in claim 8 wherein said encoded image or datagram comprising one or a plurality of fields built up by geometrical elements arranged according to predetermined formats according to said service access levels in order to enable said remote data processing centre to decode part or all of said sent information associated with said image at the proper service level, and/or
wherein said information being embedded within a complex image and needing a more complex encoding and decoding algorithm for providing higher level of security.

10. A system for fixed or wireless image-initiated service-access via a remote server platform as disclosed in claim 8 wherein said services comprising the activation of specific systems or equipment wherein said specific systems or equipment being a car park barrier or a corporate or private building access door or point of sale access or restricted personal area entry point or machinery operation systems.

11. A system for fixed or wireless image-initiated service-access via a remote server platform as disclosed in claim 8 wherein said services comprising food packaging information including use-by date and origin and/or temperature changes of said food packaging, wherein said wireless information retrieval system being connected to a retailer and/or a wholesale point allowing the traceability and validity of said food instantaneously wherein a client or a store personal or a manager each having different access level to the encoded information.

12. A system for fixed or wireless image-initiated service-access via a remote server platform em as disclosed in claim 8 wherein said services being in a restaurant, or in other customer service applications, wherein patrons of image capturing images from datagrams printed in menus and using transmission over a network in order to more efficiently request service or report their choices to the kitchen and/or to the computer for efficiently managing the stocks.

13. A system for fixed or wireless image-initiated service-access via a remote server platform as disclosed in claim 8 wherein said encoded datagrams comprising computer upgrade instructions allowing said data acquisition device to be directly programmed by graphical information.

14. A system for fixed or wireless image-initiated service-access via a remote server platform as disclosed in claim 8 wherein said custom encoded images being created for a specific application and having relevance only to said specific application software when decoded by a receiver processor.

15. A system for fixed or wireless image-initiated service-access via a remote server platform as disclosed in claim 8 further comprising means for providing,
a secure transactions for purchasing goods and services or
unpaid services requesting data on a product or service, or services requesting public documents or
unpaid services granting access to competitions in exchange for advertising or
unpaid services for providing data about mortgages, bank services, and wills and testaments or
unpaid services providing educational information on sought subjects.
